(19) United States
(12) Patent Application Publication
(10) Pub. No.: US 2020/0320634 A1
(43) Pub. Date: Oct. 8, 2020

(54) Systems and Methods for an Augmented Stock and Investment Screener

(71) Applicant: FMR LLC, Boston, MA (US)

(72) Inventors: John Dance, Chung Hom Kok (HK); Amit Shavit, Boston, MA (US); Vineel Gujjar, Cumberland, RI (US); Michael Canny, Somerville, MA (US); John Avery, Cambridge, MA (US)

(21) Appl. No.: 16/839,616

(22) Filed: Apr. 3, 2020

Related U.S. Application Data
(60) Provisional application No. 62/829,076, filed on Apr. 4, 2019.

(51) Int. Cl. G06Q 40/06; G06N 5/04; G06N 20/00

(52) U.S. Cl. CPC G06Q 40/06; G06N 20/00; G06N 5/04

(57) ABSTRACT

Systems and methods for scoring investment data using machine learning-based model training. The method includes receiving historical data over a time period. The method further includes determining positive investment data and negative investment data based on the historical data and investment preference data. The positive investment data including characteristics associated with positive assets that align with the investment preference data. The negative investment data including characteristics associated with negative assets that misalign with the investment data. The method further includes calculating machine learning model parameters based on the positive and negative investment data. The method also includes calculating a score corresponding to a new asset based on the machine learning model parameters and new investment data. The method further includes determining whether the new investment data aligns with the investment preference data based on the score and a threshold investment score.

### CROSS REFERENCE TO RELATED APPLICATIONS

This application claims the benefit of priority to U.S. Provisional Patent Application No. 62/829,076, filed Apr. 4, 2019, the entire contents of which are owned by the assignee of the instant application and incorporated herein by reference in its entirety.

### FIELD OF THE INVENTION

The present invention relates generally to systems and methods for training machine learning-based models using historical data, including systems and methods for scoring investment data using machine learning-based model training.

### BACKGROUND OF THE INVENTION

Historically, portfolio managers are professionals responsible for making investment decisions on behalf of clients. Portfolio managers are responsible for establishing an investment strategy or philosophy. Generally, the goal of an investment philosophy is to select appropriate investments such that the investments, as a whole, earn a greater return than a given level of risk. Portfolio managers often work with teams of analysts and researchers to develop and apply a successful investment philosophy.

In response to these challenges, manual analysis or rule-backed stock screeners have been employed by portfolio managers to review a large universe of stocks, sometimes tens of thousands, in an attempt to identify successful investable companies. However, manual analysis is effort intensive and difficult to apply consistently. Further, rule-based systems force portfolio managers to express their complex philosophy in terms of simplistic rules that may not adequately capture the philosophy.

### SUMMARY OF THE INVENTION

Accordingly, an object of the invention is to provide portfolio managers with systems and methods for analyzing investment data. It is an object of the invention to provide portfolio managers with systems and methods for analyzing investment data over a time period. It is an object of the invention to provide portfolio managers with systems and methods for analyzing investment data using a machine learning-based model. It is an object of the invention to provide portfolio managers with systems and methods for training machine learning-based models using historical data. It is an object of the invention to provide portfolio managers with systems and methods for scoring investment data using machine learning-based model training.

In some aspects, a method for scoring investment data using machine learning-based model training includes receiving, by a server computing device, historical data from a first database. The historical data includes investment data over a time period. The method further includes determining, by the server computing device, positive investment data based on the historical data and investment preference data. The positive investment data includes characteristics associated with positive assets that align with the investment preference data. The method also includes determining, by the server computing device, negative investment data based on the historical data and the investment preference data. The negative investment data includes characteristics associated with negative assets that misalign with the investment preference data.

Further, the method includes calculating, by the server computing device, machine learning model parameters based on the positive investment data and the negative investment data. The method also includes receiving, by the server computing device, new investment data from a second database. The new investment data includes characteristics of a new asset. The method further includes calculating, by the server computing device, a score corresponding to the new asset based on the machine learning model parameters and the new investment data. The score corresponds to a probability of alignment with the investment preference data. Further, the method includes determining, by the server computing device, whether the new investment data aligns with the investment preference data based on the score and a threshold investment score.

In some embodiments, the investment data includes stock prices for companies. In other embodiments, the time period includes one of five years, six years, seven years, eight years, or nine years. In some embodiments, the investment preference data corresponds to an investment preference of a portfolio manager.

In some embodiments, the server computing device is configured to generate stock charts based on the historical data. In other embodiments, the server computing device is configured to generate the positive investment data and the negative investment data based on the generated stock charts.

In some embodiments, the score includes a value ranging from 0 to 1. For example, in some embodiments, the threshold investment score includes a value of about 0.5.

In some embodiments, the machine learning model parameters correspond to a trained machine learning model. In other embodiments, the server computing device is configured to calculate new machine learning model parameters based on the positive investment data, the negative investment data, and the new investment data.

In some aspects, a system for scoring investment data using machine learning-based model training includes a server computing device communicatively coupled to a first database and a second database. The server computing device is configured to receive historical data from the first database. The historical data includes investment data over a time period. The server computing device is also configured to determine positive investment data based on the historical data and investment preference data. The positive investment data includes characteristics associated with positive assets that align with the investment preference data. Further, the server computing device is configured to determine negative investment data based on the historical data and the investment preference data. The negative investment data includes characteristics associated with negative assets that misalign with the investment preference data.

The server computing device is also configured to calculate machine learning model parameters based on the positive investment data and the negative investment data. The server computing device is further configured to receive new investment data from a second database. The new investment data includes characteristics of a new asset. The server computing device is also configured to calculate a score corresponding to the new asset based on the machine learning model parameters and the new investment data. The score corresponds to a probability of alignment with the investment preference data. The server computing device is further configured to determine whether the new investment data aligns with the investment preference data based on the score and a threshold investment score.

In some embodiments, the investment data includes stock prices for companies. In other embodiments, the time period includes one of five years, six years, seven years, eight years, or nine years. In some embodiments, the investment preference data corresponds to an investment preference of a portfolio manager.

In some embodiments, the server computing device is configured to generate stock charts based on the historical data. In other embodiments, the server computing device is configured to generate the positive investment data and the negative investment data based on the generated stock charts.

In some embodiments, the score includes a value ranging from 0 to 1. For example, in some embodiments, the threshold investment score includes a value of about 0.5.

In some embodiments, the machine learning model parameters correspond to a trained machine learning model. In other embodiments, the server computing device is configured to calculate new machine learning model parameters based on the positive investment data, the negative investment data, and the new investment data.

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of an exemplary data communications network according to embodiments of the technology described herein.

FIG. 2 is a block diagram of an exemplary server computing device and an exemplary mobile device according to embodiments of the technology described herein.

FIG. 3 is a diagram showing a visualization of an exemplary model building process according to embodiments of the technology described herein.

FIG. 4 is a diagram showing a visualization of an exemplary data collection process for the exemplary model building process shown in FIG. 3, according to embodiments of the technology described herein.

FIG. 5 is a diagram showing a visualization of an exemplary stock chart over a time period, according to embodiments of the technology described herein.

FIG. 6 is a diagram showing a visualization of an exemplary model scoring process, according to embodiments of the technology described herein.

FIG. 7 is a flow diagram of a computer-implemented method for scoring investment data using machine learning-based model training, according to embodiments of the technology described herein.

### DETAILED DESCRIPTION OF THE INVENTION

Portfolio managers study a large universe of stocks, sometimes tens of thousands, in attempt to identify successful investment companies. This screening of stocks is governed by the portfolio manager's proprietary investment philosophy, which entails manually reviewing trends in historical stock financial metrics, and making investment judgements. The stock financial metrics that are considered include fundamentals such as stock price, sales, earning, and other derived metrics such as market sentiment, governance & compliance, and CEO performance perceptions. Clearly, this type of manual analysis is very effort intensive, and hard to apply consistently. Hence, rule-based stock screeners have historically been employed to help alleviate the burden. However, the rule-based systems themselves have their limitations, because it forces the portfolio manager to express his or her complex philosophy in terms of simplistic rules that might inadequately capture the philosophy.

In some aspects, the systems and methods described herein is a machine learning alternative to the stock screening process where an artificial intelligence-based model is trained by means of ground-truth examples or historical data, to mimic the investment philosophy of the portfolio manager. The trained model can be scalably applied to a large universe of investment data, and the scoring process can be repeated frequently as newer data becomes available, in order to closely track changes in stock performance. The systems and methods described herein provide a more comprehensive and scalable solution compared to manual analysis or rule-backed stock screeners.

In some aspects, the systems and methods described herein can include one or more mechanisms or methods for providing portfolio managers with systems and methods for analyzing investment data. The system and methods can include mechanisms or methods for analyzing investment data over a time period. The systems and methods described herein can facilitate portfolio managers by analyzing investment data using a machine learning-based model. The systems and methods described herein can include one or more mechanisms or methods for providing portfolio managers with systems and methods for training machine learning-based models using historical data. The systems and methods described herein can facilitate portfolio managers by scoring investment data using machine learning-based model training.

The systems and methods described herein can develop a set of scalable machine learning models that systematically learn a portfolio manager's philosophy by training the models using examples and characteristics of companies that the portfolio manager deems as potential winners. The machine learning models can continue to learn and adapt based on the stocks the portfolio manager chooses and continue to refine itself to better fit the portfolio manager's intended investment philosophy. Hence, the systems and methods described herein do not require the definition of a set of hard logical and/or static rules. Further, the systems and methods described herein do not seek to merely automate manual analytical processes by a portfolio manager, but rather replace the portfolio manager altogether by learning his or her preferences and using these preferences to select new investable companies without any human intervention. The predictions made by the machine learning models of the systems and methods described herein are adapted to eliminate potential human errors that can be made by a portfolio manager, such as irrational or emotion-driven decisions or erroneous data entry.

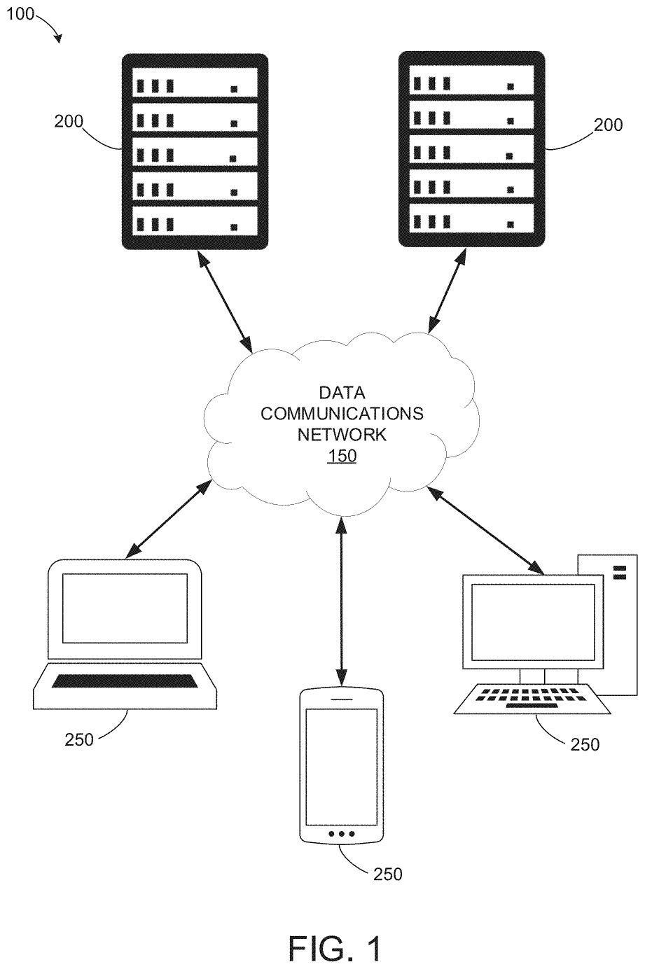

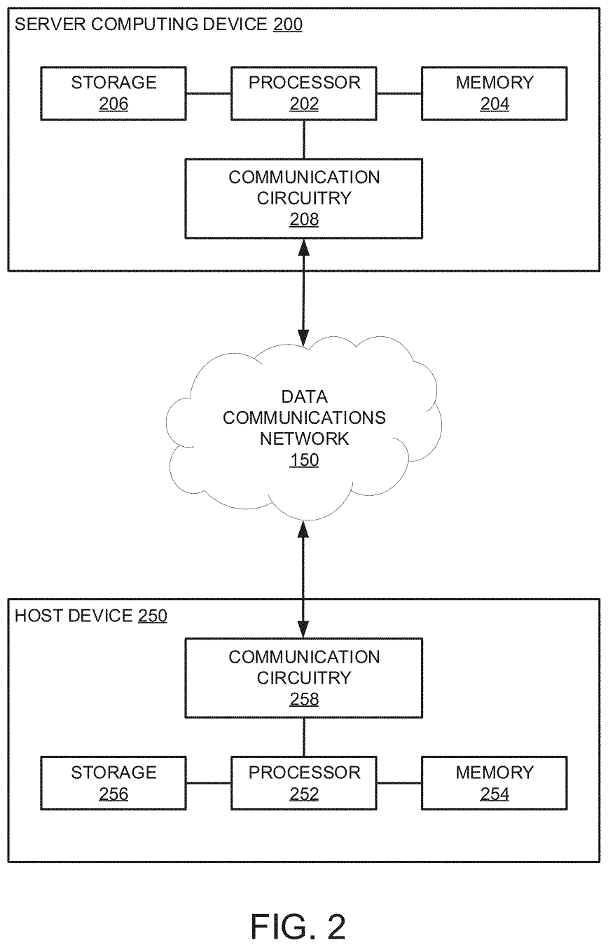

Referring to FIGS. 1 and 2, an exemplary communications system 100 includes data communications network 150, exemplary server computing devices 200, and exemplary mobile devices 250. In some embodiments, the system 100 includes one or more server computing devices 200 and one or more mobile devices 250. Each server computing device 200 can include a processor 202, memory 204, storage 206, and communication circuitry 208. Each mobile device 250 can include a processor 252, memory 254, storage 256, and communication circuitry 258. In some embodiments, communication circuitry 208 of the server computing devices 200 is communicatively coupled to the communication circuitry 258 of the mobile devices 250 via data communications network 150. Communication circuitry 208 and communication circuitry 258 can use Bluetooth, Wi-Fi, or any comparable data transfer connection. The mobile devices 250 can include personal workstations, laptops, tablets, mobile devices, or any other comparable device.

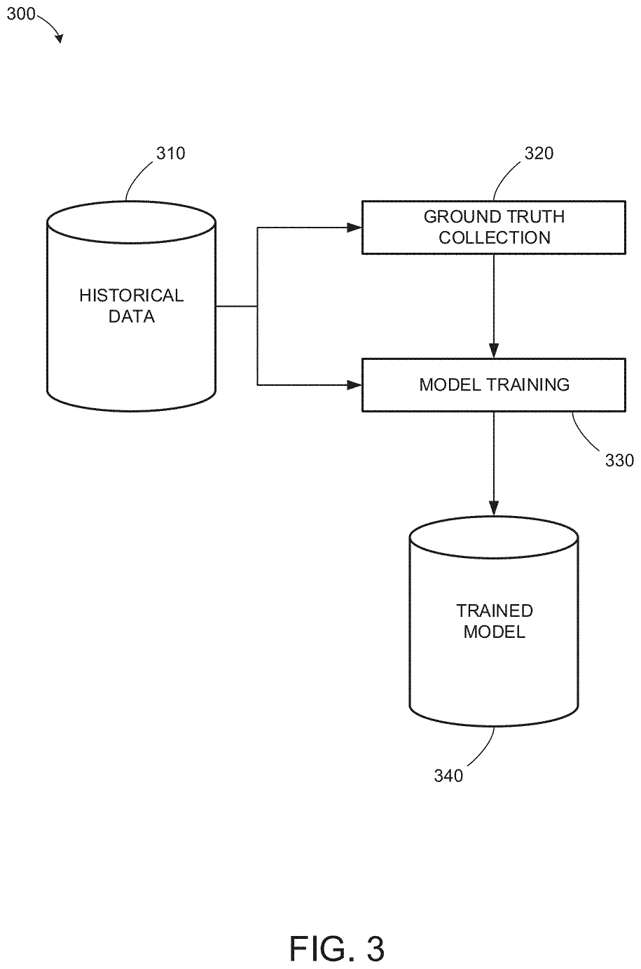

An exemplary model building process 300 is illustrated in FIG. 3. As shown, the model building process starts with collecting ground truth 320 from historical data 310. For example, the historical data 310 can include a dataset of stock charts. In some embodiments, historical data 310 includes the ticker symbol for a particular asset, the date for the metrics of the assets, the stock price, the price earnings ratio, the price to book ratio, the cumulative returns of the stock, the book value per share, the earnings per share, and relative metrics such as an index. The historical data 310 can be depicted in tabular form.

The ground-truth comprises historical examples of cases where the stock performance met the portfolio manager's expectations (hereinafter referred to as “positive class”), and those that did not (hereinafter referred to as “negative class”). Thus, the ground-truth dataset includes examples of stocks that align with the portfolio manager's investment preferences or philosophy, and those that don't. In some embodiments, the portfolio manager's investment philosophy can be classified as structural growth, disruptive growth, PE rerate, or noise (other). In other embodiments, the portfolio manager's investment philosophy can be classified as growth stocks, value stocks, core stocks, and dislike stocks.

The ground-truth data are then fed to a machine learning system as a part of model training 330. Model training 330 is an automated algorithmic process of identifying a mathematical formulation that can distinguish between the positive and the negative class. In simple terms, a machine learning model maps input data X to an output label Y using its trained parameters Θ. The output of the model training process is a trained model 340. Specifically, the models of the systems and methods described herein are adapted to learn the intrinsic patterns and trends present in the ground truth data that appear to capture the subtle investment philosophy of the portfolio manager (e.g., distinguish between positive and negative investment criteria).

Furthermore, as additional ground truth samples enter the system, the models continue to retrain in the background and evaluate their performance through metrics such as precision, recall, area under the receiver operating characteristic curve, and F1 score. The trained models can then be applied in the future to never-seen-before datasets and generate predictions on those datasets without human intervention, such as without being processed/analyzed by the portfolio manager. The models can be used to score thousands of stocks in real time or near real time.

Several types of models can be used for model training. For example, XGBoost, GADF, LSTM classifier, or Inception CNN (or convolutional neural network) can be used as classification models. XGBoost is a standard machine learning classifier where each raw data from each training instance is transformed to a set of features. In some embodiments, the time-series data from the training instance is transformed into a 2D matrix using GADF (Gramian Angular Difference Field). The 2D matric can be interpreted as an image dataset, and standard Convolutional Neural Network classifiers can be trained using these “images” as input. Each time series of a metric forms a channel to the CNN.

In some aspects, ensembling Random Forest, XGBoost, and LightGBM models provides improvements over using only one of those models in isolation. This is primarily because each model works in different ways and is able to learn different patterns and trends in the data. Random Forest works by building trees that yield the best splits (i.e., the splits in the data that most reduce entropy) and continues recursively until stopping criterions are reached. Some tree pruning methods are then followed to help prevent overfitting and to reduce computational runtimes. In the tradeoff between variance and bias, Random Forest primarily goes after the variance by aggregating uncorrelated trees. XGBoost and LightGBM work differently than random forest, mainly by using a boosting algorithm, and in such, primarily go after the bias rather than the variance. XGBoost grows its trees depth-wise, while LightGBM grows its trees leaf-wise. Even this slight nuance in how these two models grow their trees generates enough of a difference between the models to capture different variance in the data, adding more value to ensembling.

All three models are optimized using the cross entropy objective function, and work on the same set of underlying features. The LightGBM uses the leaf-wise tree growing algorithm to build its trees throughout training. Features can be engineered using a wide array of extractive techniques. For example, looking at the range, min, max, mean, median over a growing time window for each series. In some embodiments, other techniques are used such as Fourier transforms of the original series with different lag parameters, autocorrelations over time, and various entropy measures. Up to hundreds of features are generated for each time series, which significantly help the models learn the various nuances present in each objective class. The models are ensembled together using the mean of their respective scores.

In some aspects, stock classification data can be modeled using computer vision models. For example, in some embodiments, the financial data is charted, and those charts are used as inputs to computer vision models such as Inception V3 or VGG16. Computer vision models can then be applied to the underlying financial data. Computer vision or convolutional neural network models can be applied on time series data using recurrence plots of such data. Converting a time series of price, for example, to its recurrence plot, generates a 2D representation of the time series.

Neural network models can then be applied to the underlying data. For example, long short term memory (LSTMs) and gated recurrent units (GRUs) can be employed to model the time series. Classical machine learning models can then be applied on the extracted features. For example, extracting features such as Fourier transforms, autocorrelations, periodicity, or peaks can be used as inputs to classical machine learning models such as logistic regressions, Random Forests, or extreme gradient boosted trees. Ensembling these models together yield improved performance and metrics. The models described herein can be interchanged, and are automatically chosen and ensembled to maximize performance.

In some aspects, for some types of models, such as deep learning models, the model scoring process can be interpreted as a two stage process. For example, the first stage can convert the input instance into a vector of numbers. The vector of numbers are then used to generate the predicted class. The advantage of the two-stage interpretation is that each input instance can now be represented as a vector of numbers that encode the characteristics of the stock metrics. The sets of vectors can now be used to cluster similar instances. Each cluster can be evaluated by a Portfolio Manager for investment decisions in a semi-supervised fashion.

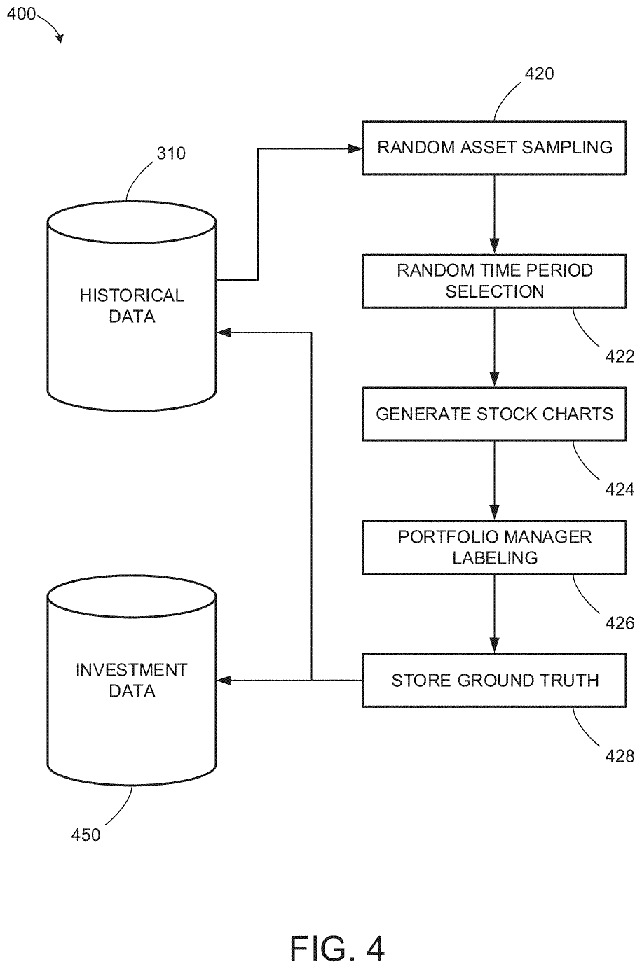

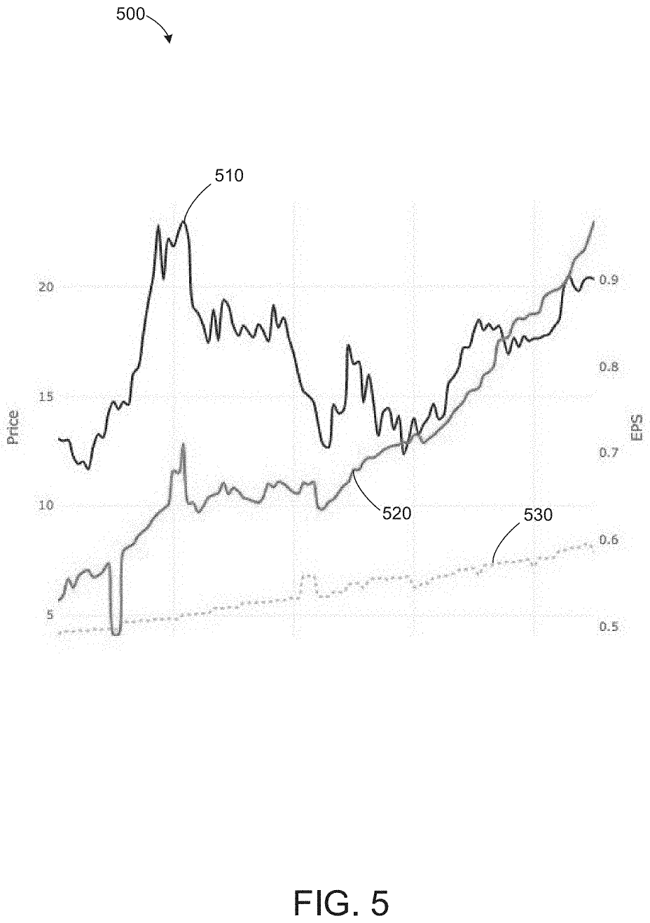

Referring to FIG. 4, an exemplary ground-truth collection process 400 is illustrated. Process 400 begins by randomly sampling an asset from historical data 310 at step 420 and randomly choosing a time period at step 422. Process 400 continues by generating a stock chart for the randomly sampled asset over the randomly chosen time period at step 424. For example, FIG. 5 illustrates an exemplary stock chart 500 for an asset over a time period of 8 years. Stock chart 500 illustrates the stock price 510, the earnings per share 520, and book value per share 530.

Process 400 continues by receiving a label from a portfolio manager for the generated stock chart at step 426. The portfolio manager labels the generated stock chart as potentially investible (positive class) or not potentially investible (negative class). Process 400 continues at step 428 by storing the label corresponding to the randomly sampled asset as investment data 450. The ground-truth collection process 400 returns to step 420 to randomly sample another asset from historical data 310. As discussed in relation to FIG. 3, the investment data 450 is then fed to the machine learning system as a part of model training 330.

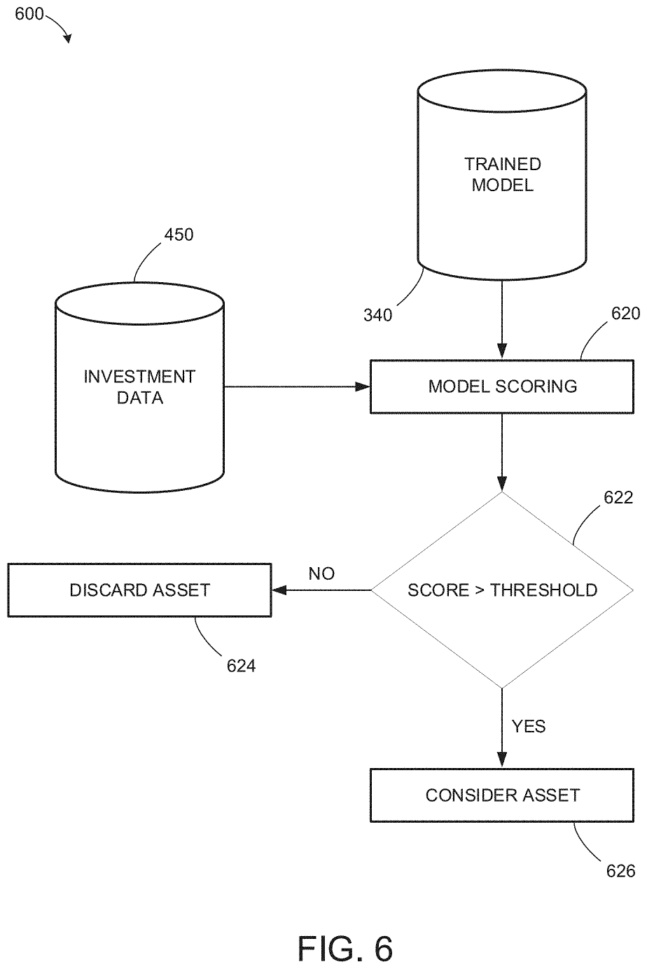

FIG. 6 illustrates an exemplary model scoring process 600. Process 600 begins by receiving a new asset to score from investment data 450. The new asset is scored at step 620 using the trained model 340. For a new asset, the model scoring process can generate an output probability score ranging from 0 to 1, where the higher the score, the higher the chance that the stock aligns with the portfolio manager's philosophy. The threshold is the value at which an asset is deemed aligned with the portfolio manager's preferences or philosophy. In some embodiments, the threshold is determined experimentally using statistics generated from the model training process. In other embodiments, the threshold investment score can be a value of about 0.5, about 0.6, about 0.7, about 0.8, or about 0.9. The model scoring process 600 can also be repeated periodically to track changes in stock performance over time.

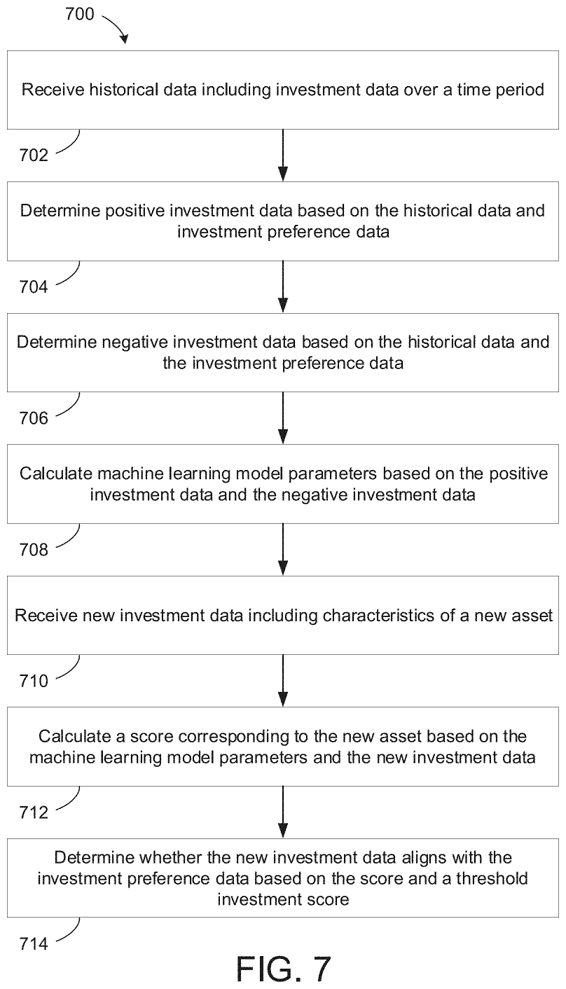

Referring to FIG. 7, a process 700 for scoring investment data using machine learning-based model training is illustrated. The process 700 begins by receiving, by a server computing device 200, historical data from a first database step 702. For example, in some embodiments, the historical data includes investment data over a time period. The investment data can include stock prices of companies listed on exchange markets. In some embodiments, the time period can be one of one year, two years, three years, four years, five years, six years, seven years, eight years, nine years, or ten years.

Process 700 continues by determining, by the server computing device 200, positive investment data based on the historical data and investment data in step 704. For example, in some embodiments, the positive investment data includes characteristics associated with positive assets that align with the investment preference data. The investment preference data can correspond to an investment preference of a portfolio manager.

Process 700 continues by determining, by the server computing device 200, negative investment data based on the historical data and the investment preference data in step 706. For example, in some embodiments, the negative investment data includes characteristics associated with negative assets that misalign with the investment preference data.

In some embodiments, the server computing device 200 can be configured to generate stock charts based on the historical data. For example, in some embodiments, the server computing device 200 can be configured to generate the positive investment data and the negative investment data based on the generated stock charts. In other embodiments, the positive investment data and the negative investment data can be generated based on feedback received by the portfolio manager.

Process 700 continues by calculating, by the server computing device 200, machine learning model parameters based on the positive investment data and the negative investment data in step 708. As discussed above in relation to FIGS. 3-5, the machine learning model parameters correspond to a trained machine learning model.

Process 700 continues by receiving, by the server computing device 200, new investment data from a second database in step 710. For example. in some embodiments, the new investment data includes characteristics of a new asset. A new asset can be a new stock that is being considered by the portfolio manager. In other embodiments, the server computing device can receive the new investment data from the first database.

Process 700 continues by calculating, by the server computing device 200, a score corresponding to the new asset based on the calculated machine learning model parameters and the new investment data in step 712. For example, in some embodiments, the score corresponds to a probability of alignment with the investment preference data. As discussed above in relation to FIG. 6, the score can be a value ranging from 0 to 1. In some embodiments, a score closer to 1 indicates that the probability of alignment with the investment preference data is high. Similarly, in some embodiments, a score closer to 0 indicates that the probability of alignment with the investment preference data is low.

Process 700 finishes by determining, by the server computing device 200, whether the new investment data aligns with the investment preference data based on the score and a threshold investment score in step 714. In some embodiments, the threshold investment score can be a value of about 0.5, about 0.6, about 0.7, about 0.8, or about 0.9. For example, in some embodiments, the server computing device 200 can determine that the new investment data aligns with the investment preference data if the score is above the threshold investment score.

In some embodiments, the server computing device 200 can be configured to calculate new machine learning model parameters based on the positive investment data, the negative investment data, and the new investment data. The new machine learning model parameters can be used by the server computing device 200 to calculate a new score corresponding to other assets.

The systems and methods described herein use artificial intelligence and machine learning to learn a portfolio manager's philosophy. The systems and methods described herein are able to adapt over time to different factors such as market regimes, changes in philosophy, and is able to accurately tailor itself to a specific portfolio manager in a consistent manner.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed:

1. A method for scoring investment data using machine learning-based model training, the method comprising:
receiving, by a server computing device, historical data from a first database, wherein the historical data comprises investment data over a time period;
determining, by the server computing device, positive investment data based on the historical data and investment preference data, wherein the positive investment data comprises characteristics associated with positive assets that align with the investment preference data;
determining, by the server computing device, negative investment data based on the historical data and the investment preference data, wherein the negative investment data comprises characteristics associated with negative assets that misalign with the investment preference data;
calculating, by the server computing device, a plurality of machine learning model parameters based on the positive investment data and the negative investment data;
receiving, by the server computing device, new investment data from a second database, wherein the new investment data comprises characteristics of a new asset;
calculating, by the server computing device, a score corresponding to the new asset based on the plurality of machine learning model parameters and the new investment data, wherein the score corresponds to a probability of alignment with the investment preference data; and
determining, by the server computing device, whether the new investment data aligns with the investment preference data based on the score and a threshold investment score.

2. The method of claim 1, wherein the investment data comprises stock prices for a plurality of companies.

3. The method of claim 1, wherein the time period comprises one of five years, six years, seven years, eight years, or nine years.

4. The method of claim 1, wherein the investment preference data corresponds to an investment preference of a portfolio manager.

5. The method of claim 4, wherein the server computing device is configured to generate a plurality of stock charts based on the historical data.

6. The method of claim 5, wherein the server computing device is configured to generate the positive investment data and the negative investment data based on the plurality of stock charts.

7. The method of claim 1, wherein the plurality of machine learning model parameters corresponds to a trained machine learning model.

8. The method of claim 1, wherein the score comprises a value ranging 0 to 1.

9. The method of claim 8, wherein the threshold investment score comprises a value about 0.5.

10. The method of claim 1, wherein the server computing device is configured to calculate a new plurality of machine learning model parameters based on the positive investment data, the negative investment data, and the new investment data.

11. A system for scoring investment data using machine learning-based model training, the system comprising:
a server computing device communicatively coupled to a first database and a second database, the server computing device configured to:
receive historical data from the first database, wherein the historical data comprises investment data over a time period;
determine positive investment data based on the historical data and investment preference data, wherein the positive investment data comprises characteristics associated with positive assets that align with the investment preference data;
determine negative investment data based on the historical data and the investment preference data, wherein the negative investment data comprises characteristics associated with negative assets that misalign with the investment preference data;
calculate a plurality of machine learning model parameters based on the positive investment data and the negative investment data;
receive new investment data from a second database, wherein the new investment data comprises characteristics of a new asset;
calculate a score corresponding to the new asset based on the plurality of machine learning model parameters and the new investment data, wherein the score corresponds to a probability of alignment with the investment preference data; and
determine whether the new investment data aligns with the investment preference data based on the score and a threshold investment score.

12. The system of claim 11, wherein the investment data comprises stock prices for a plurality of companies.

13. The system of claim 11, wherein the time period comprises one of five years, six years, seven years, eight years, or nine years.

14. The system of claim 11, wherein the investment preference data corresponds to an investment preference of a portfolio manager.

15. The system of claim 14, wherein the server computing device is configured to generate a plurality of stock charts based on the historical data.

16. The system of claim 15, wherein the server computing device is configured to generate the positive investment data and the negative investment data based on the plurality of stock charts.

17. The system of claim 11, wherein the plurality of machine learning model parameters corresponds to a trained machine learning model.

18. The system of claim 11, wherein the score comprises a value ranging 0 to 1.

19. The system of claim 18, wherein the threshold investment score comprises a value about 0.5.

20. The system of claim 11, wherein the server computing device is configured to calculate a new plurality of machine learning model parameters based on the positive investment data, the negative investment data, and the new investment data.
